(19) United States
(12) Patent Application Publication
(10) Pub. No.: US 2010/0072260 A1
(43) Pub. Date: Mar. 25, 2010

(54) SOLDERING TIP HAVING A SURFACE WITH A GRID STRUCTURE

(76) Inventors: Thomas Stiller, Erdmannhausen (DE); Walter Brader, Neckarwestheim (DE); Laslo Jackovic, Hessigheim (DE)

Correspondence Address: COATS & BENNETT, PLLC, 1400 Crescent Green, Suite 300, Cary, NC, 27518, US

(21) Appl. No.: 12/527,606

(22) PCT Filed: Jan. 9, 2008
(86) PCT No.: PCT/EP2008/000122

§ 371 Date: Nov. 17, 2009

(30) Foreign Application Priority Data
Feb. 19, 2007 (DE) 20 2007 002 436.3

(51) Int. Cl. B23K 3/02

(52) U.S. Cl. 228/54

(57) ABSTRACT

A soldering tip for a soldering device which comprises a heat generating or heat conducting base body, and which on the outside thereof has a contact surface that can be wetted by solder at least in sections. The material of the contact surface has a lattice structure. Charged elementary particles of at least one foreign material are incorporated into the lattice structure of the contact surface.

The present invention refers to a soldering tip for a soldering or desoldering device, which is generally referred to as a soldering device, with the soldering tip being formed according to the preamble of claim 1. Thus the invention equally refers to active and passive soldering tips. With active soldering tips the base body itself serves under supply of electrical energy as a (resistive) heating element, i.e., it generates heat. By contrast, with passive soldering tips, heat is generated by an external heating element and transported to the soldering tip. The base body in such a passive soldering tip is therefore primarily heat-conducting. Therefore, the base body (or “core”) of a passive soldering tip is often made of copper or silver.

It is true that copper and silver are easily wettable by the solder material, particularly by tin solder. At the same time, however, they exhibit a very high dealloying rate in liquid tin, i.e. they have a correspondingly short lifetime.

It is known that the lifetime is prolonged by electrodepositing an iron layer on the base body or “core”. Iron is still easily wettable with tin, but exhibits a much lower dealloying rate in comparison with copper or silver.

One problem is that since recently only lead-free solder alloys are allowed. Such lead-free solder materials increase the dealloying rate due to an increased amount of tin in the alloy and due to a higher melting temperature. The fluxes needed for such solders also have a negative impact on the service life and on the wettability of the iron layer.

It is the object of the present invention to provide a soldering tip in which the long-term flow behavior is considerably improved in comparison with conventional soldering tips. This object is achieved by a soldering tip comprising the features of claim 1. Advantageous developments of the invention are indicated in the sub-claims.

Already with conventional soldering tips the material of the contact surface that is wettable by tin solder is configured such that its atoms are arranged in a metallic or crystal lattice structure. The invention now provides that charged elementary particles of at least one foreign material are incorporated into this lattice structure of the contact surface, the term “foreign material” in this context encompassing any material differing from the main or base material of the contact surface. The original lattice structure of the contact surface is changed due to the incorporation of the charged elementary particles of the foreign material. Surprisingly it has been found that the contact surface is thereby wettable in a considerably improved way and that in addition it becomes mechanically much more stable. Both effects improve the long-term flow behavior of the soldering tip.

Of particular advantage is the modified contact surface according to the invention in ultrafine soldering tips used for microelectronics because such soldering tips have so far only exhibited a very low inherent stability due to their configuration and therefore have a very limited lifetime. Since the contact surface of such soldering tips can be stabilized mechanically by the incorporation of charged elementary particles, the mean lifetime of said soldering tips can also be extended considerably.

It is conceivable that a special contact layer is first provided on the base body, said contact layer already exhibiting a particularly good wettability, and that the modified contact surface according to the invention is the surface of said contact layer. The wettability of the contact surface is thereby improved twice.

In another variant the contact surface may be the surface of the base body itself. This variant of embodiment offers the advantage that the soldering tip is of a very simple construction because no additional layers need to be provided on the base body. In the absence of the additional coatings such a soldering tip can also taper to a considerable extent, so that it is especially suited for microelectronic applications.

Depending on the type of foreign material and on the type of incorporation, the charged elementary particles of the foreign material can be incorporated on lattice sites of the lattice structure of the contact surface and/or on interstices.

It is expedient when in addition to the charged elementary particles of a first foreign material also charged elementary particles of at least one second foreign material are incorporated into the contact surface. Depending on the selection of the respective foreign materials, either one effect (e.g. wettability) could particularly be intensified or, however, two different effects (wettability and mechanical stability) could be promoted.

The foreign materials, the charged elementary particles of which could be incorporated into the contact surface, are e.g. platinum, tungsten, molybdenum, titanium, cobalt, germanium, silicon, arsenic, gallium, nitrogen or carbon. The incorporation of charged elementary particles of platinum, tungsten, molybdenum, titanium, nickel or cobalt generally improve the lifetime of the soldering tips according to the invention. If charged elementary particles of germanium, silicon, arsenic or gallium are incorporated into the lattice structure of the contact surface, the wettability of the soldering tip will improve. The incorporation of nitrogen or carbon has the effect that the soldering tips can withstand a higher mechanical load.

Preferably, the charged elementary particles of the foreign material are homogeneously distributed on the contact surface. The long-term flow behavior on the whole soldering tip can thereby be improved without the formation of weak spots or spots of reduced wettability.

Inversely, however, it is also conceivable to vary the density of the charged elementary particles across the soldering tip. It could thereby e.g. be achieved that the outermost tip of the soldering tip is mechanically particularly firm, or the flow of the solder material towards the outermost tip could be promoted.

According to the invention the charged elementary particles can be incorporated into a lattice structure not only directly on the contact surface itself, but also in the volume underneath the contact surface.

This would have the advantage that the surface conditions are maintained even if the contact surface should wear during operation of the soldering tip.

If charged elementary particles are also present underneath the contact surface in the volume of the soldering tip, it would be conceivable that the concentration of said charged elementary particles changes with an increasing depth underneath the contact surface. For instance, the concentration of the charged elementary particles could decrease, so that upon wear of the soldering tip the wettability thereof will deteriorate, thereby signaling to the user that the soldering tip should be replaced.

On the other hand, it would also be conceivable that the concentration of the charged elementary particles increases with an increasing depth underneath the contact surface. For instance, the interior of the soldering tip could thereby be made mechanically particularly stable.

Preferably, the charged elementary particles are provided not only directly on the contact surface, but at least up into a depth of 0.3 mm underneath the contact surface. Even further preferred is the provision of the charged elementary particles up into a depth of at least 1.0 mm. It can thereby be achieved that the improved flow behavior of the solder material is maintained as long as possible on the soldering tip even upon wear of the soldering tip.

It is possible that the depth up to which charged elementary particles are incorporated into the lattice structure varies across the soldering tip. This depth could e.g. depend on the diameter of the soldering tip at the respective place.

If a contact layer is provided on the outside of the soldering tip, at least one further layer could be provided between the base body and said contact layer with which the properties of the soldering tip according to the invention are further modified and improved.

For instance, at least one barrier layer could be provided between the base body and the contact layer. This barrier layer could have the function to prevent the penetration or diffusion of the charged elementary particles into deeper regions of the soldering tip. Another barrier effect could ensue due to the fact that the barrier layer is not wettable by tin solder so as to protect the interior core or base body of the soldering tip in this way.

Moreover, a protective coating could also be provided on sections on the outside of the contact surface so as to prevent a wetting of the contact surface at selected locations. It would also be conceivable to apply such a protective coating at specific places where the incorporation of charged elementary particles into the contact surface is to be prevented. Suited for this purpose are protective coats containing tin, silver or gold.

A preferred embodiment of the invention shall now be explained in more detail with reference to a drawing, which shows in detail in

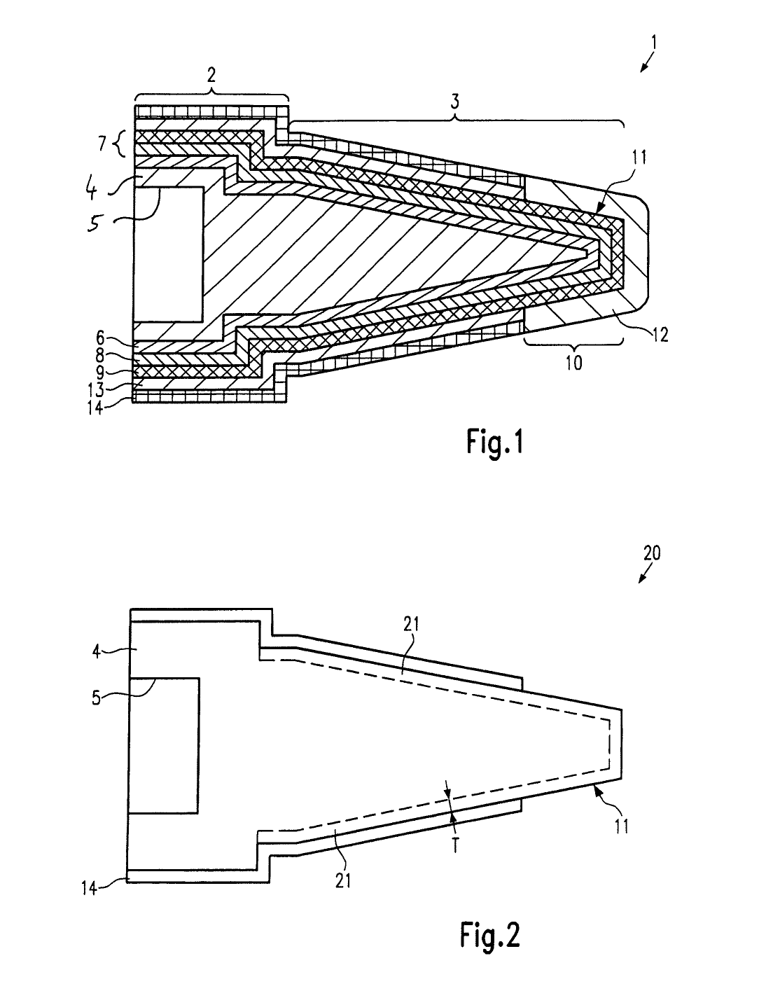

FIG. 1 a vertical section through a first embodiment of a soldering tip according to the invention; and

FIG. 2 a vertical section through a second embodiment of a soldering tip according to the invention.

Like components are designated by like reference numerals throughout the figures.

FIG. 1 shows a first embodiment of a soldering tip 1 according to the invention for a soldering device. The soldering tip 1 is in axial symmetry with a substantially cylindrical shaft 2 and an adjoining conical section 3. The illustrated embodiment relates to a passive soldering tip 1 that in its interior comprises a heat conducting base body 4, which may e.g. consist of copper or silver. In an active soldering tip the base body 4 would comprise a heating element and possibly a temperature sensor.

The cylindrical shaft 2 has provided thereon a fastening element 5 which is here configured as a recess and by means of which the soldering tip can be fastened to the soldering device. For instance, the soldering tip 1 could be attached onto a soldering iron of the soldering device. To ensure a better grip on the soldering iron, a notch could also be provided on the fastening element 5.

A barrier layer 6 is provided on the surface of the base body 4. The barrier layer 6, which is not wettable by solder material, is fused with the surface of the base body 4. Should the barrier layer 6 consist of a metal, it may be connected to the base body 4 particularly in a metal fusion process. Its layer thickness may be in the range of 50 micrometers to about one millimeter. It serves to protect the base body 4 from wetting and thus from removal by the solder material.

The outside of the barrier layer 6 has provided thereon a contact layer 7 that is composed in the form of a crystal lattice structure. The contact layer 7 comprises an inner region 8 and an outer region 9. In a working area 10 at the front end of the soldering tip 1, the outer region 9 of the contact layer 7 is exposed. Its exposed surface forms the contact surface 11 that is wettable by the solder material 12.

Charged elementary particles of a foreign material are incorporated into the lattice structure of the outer region 9 of the contact layer 7 and thus also into the lattice structure of the contact surface 11. In the illustrated embodiment the contact layer 7 is an iron layer. Charged elementary particles of platinum, tungsten, molybdenum, titanium, nickel, cobalt, germanium, silicon, arsenic, gallium, nitrogen and/or carbon are inserted into the outer regions 9 of the contact layer 7 so as to improve the long-term flow behavior of the soldering tip 1 in this way.

A protective layer 14 is provided behind the working area 10 on the rear part of the soldering tip 1 on a carrier layer 13, the carrier layer 13 consisting, for instance, of nickel and the protective layer 14 of chromium. The chromium layer 14 is not wettable by solder material 12, thereby preventing the solder material 12 from flowing to the shaft 2 of the soldering tip 1. The protective layer or protective coating 14 may also contain tin, silver or gold.

FIG. 2 shows a second embodiment of a soldering tip 20 according to the invention, wherein the soldering tip 20 of the second embodiment is of a much simpler construction than the soldering tip 1 of the first embodiment. The soldering tip 20 also comprises a heat conducting base body 4 with a fastening element 5 formed as a recess. The soldering tip 1, however, is without a barrier layer and without a special contact layer. Instead of this, charged elementary particles of a foreign material differing from the material of the base body 4 are incorporated into a surface layer 21 of the base body 4. The surface layer 21 extends up into a depth T. In the working area 10 of the soldering tip 20 the surface layer 21 is exposed, so that the outside thereof represents the contact surface 11. Charged elementary particles of a foreign material (or of a several foreign materials) are also incorporated into the lattice structure of said contact surface 11. The wettability of the soldering tip 20 and the long-term flow behavior of the solder material 12 on the soldering tip 20 are thereby improved. Since a barrier layer and a special contact layer are missing, the soldering tip 20 of the second embodiment can be manufactured at lower costs and also with smaller dimensions than the soldering tip 1 of the first embodiment. In the second embodiment the soldering tip 20 also comprises a protective coating 14 on the rear part positioned behind the working area 10.

Starting from the illustrated embodiments, the soldering tip according to the invention can be modified in many ways. For instance, it is possible to incorporate charged elementary particles of different foreign materials into the lattice structure of the contact surface 1. Above all, a distinct deviation from the geometry of the soldering tips 1, 20 as shown in the figures is also possible. Moreover, the illustrated proportions are definitely not true to scale, especially since they may vary from embodiment to embodiment. In a simpler embodiment the protective coating 14 might also be dispensed with.

1. A soldering tip for a soldering device, comprising:
a heat base body with a contact surface on an outside thereof that can be wetted by tin solder at least in sections
the atoms of the material of the contact surface being arranged in a metallic or crystal lattice structure;
wherein charged elementary particles of at least one foreign material are incorporated into the lattice structure of the contact surface.

2. The soldering tip according to claim 1 wherein the contact surface is the surface of a contact layer provided on the base body.

3. The soldering tip according to claim 1 wherein contact surface is the surface of the base body.

4. The soldering tip according to claim 1 wherein the charged elementary particles are disposed on at least one of lattice sites of the lattice structure of the contact surface and interstices thereof.

5. The soldering tip according to claim 1 further comprising charged elementary particles of at least one second foreign material incorporated into the contact surface.

6. The soldering tip according to claim 1 wherein the first foreign material is selected from the group consisting of platinum, tungsten, molybdenum, titanium, nickel, cobalt, germanium, silicon, arsenic, gallium, nitrogen, and carbon.

7. The soldering tip according to claim 1 wherein the charged elementary particles of the first foreign material are homogeneously distributed on the contact surface.

8. The soldering tip according to claim 1 wherein the density of the charged elementary particles varies across the soldering tip.

9. The soldering tip according to claim 1 wherein the charged elementary particles are also incorporated below the contact surface into a lattice structure.

10. The soldering tip according to claim 9 wherein the concentration of the charged elementary particles varies with an increasing depth underneath the contact surface.

11. The soldering tip according to claim 10 wherein the concentration of the charged elementary particles decreases with an increasing depth underneath the contact surface.

12. The soldering tip according to claim 9 wherein the charged elementary particles are incorporated into the lattice structure at least up into a depth of 0.3 mm below the contact surface.

13. The soldering tip according to claim 9 wherein the depth up to which charged elementary particles are incorporated into the lattice structure varies across the soldering tip.

14. The soldering tip according to claim 1 further comprising at least one further layer disposed between the base body and the contact layer.

15. The soldering tip according to claim 1 further comprising at least one barrier layer disposed between the base body and the contact layer.

16. The soldering tip according to claim 15 wherein the barrier layer is not wettable by tin solder.

17. The soldering tip according to claim 1 wherein the contact surface is provided at least in sections with a protective coat.

18. The soldering tip according to claim 17 wherein the protective coat contains tin, chromium, silver, or gold.
